(19) United States
(12) Patent Application Publication
(10) Pub. No.: US 2019/0004000 A1
(43) Pub. Date: Jan. 3, 2019

(54) SENSOR FOR ANALYTES

(71) Applicant: Arch Chemicals, Inc., Allendale, NJ (US)

(72) Inventors: Steven Jang, Cumming, GA (US); Touraj Rowhani, Alpharetta, GA (US); Mark E. Johnson, Canton, GA (US)

(21) Appl. No.: 16/026,191

(22) Filed: Jul. 3, 2018

Related U.S. Application Data
(60) Provisional application No. 62/528,313, filed on Jul. 3, 2017.

(51) Int. Cl. G01N 27/27; G01N 27/327; G01N 27/416

(52) U.S. Cl. CPC G01N 27/27; G01N 27/4166; G01N 27/3275

(57) ABSTRACT

An electrochemical sensor is described that includes a counter electrode that prevents against electrical interference when measuring analytes in a fluid sample. The counter electrode can completely surround a working electrode and a reference electrode and can be held at a common potential voltage during operation. The counter electrode can have a U-shape for surrounding on three sides the working electrode and the reference electrode.

### RELATED APPLICATIONS

The present application is based on and claims priority to U.S. Provisional Application Ser. No. 62/528,313, having a filing date of Jul. 3, 2017, which is incorporated herein by reference in its entirety.

### BACKGROUND

Electrochemical devices are used for sensing or measuring the concentration of isolated atoms or molecules within a fluid, such as a gas or liquid. Electrochemical devices are used in numerous and different applications. For instance, thin film electrochemical sensors can be used to test analyte levels in patients in various different medical applications. For instance, such devices can be used to measure an analyte in the blood of a patient suffering from a metabolic disease, a blood disease, or any other disease that causes an imbalance in the blood. For example, thin film electrochemical devices have been used in the past for indicating blood glucose levels in patients, such as patients suffering from diabetes.

Electrochemical devices have also been used to measure analytes in aqueous systems, such as in pool and spa water. Pool and spa water, for instance, is typically monitored for free available chlorine, total available chlorine, total hardness, total alkalinity, cyanuric acid, copper, and other analytes. The above analytes are monitored and controlled in order to maintain water quality, especially water used for recreational and industrial purposes.

In the past, conventional electrochemical devices have included an electrochemical cell having two or three electrodes, such as a reference electrode, a working electrode, and a counter electrode. In conventional systems, an electronic instrument controls a voltage difference between two electrodes which can be either a positive voltage difference, a negative voltage difference, or an alternating current voltage difference either with or without positive or negative DC voltage bias. The voltage is typically controlled by injecting current into the electrochemical device through a counter electrode. In many applications, the electrochemical device measures the current flow between the working electrode and the counter electrode.

In the past, problems have been experienced, however, in preventing interference during the taking of measurements which can result in errors. These problems can become exacerbated when the electrochemical device contains multiple electrochemical cells in an attempt to simultaneously take different measurements of different analytes contained in a fluid.

In this regard, a need currently exists for an electrochemical device that can minimize or eliminate interference, such as galvanic electrical interference.

### SUMMARY

The present disclosure is generally directed to an electrochemical sensor having an electrode design that minimizes or eliminates electrical interference during the taking of measurements. The electrochemical sensor of the present disclosure is particularly well suited for measuring one or more analytes in a fluid, such as a liquid or a gas.

In one embodiment, the electrochemical sensor of the present disclosure includes a plurality of electrochemical cells for simultaneously sensing the concentration of the same or different chemicals or analytes within a fluid. Due to the electrode design of each electrochemical cell, simultaneous measurements can occur without any significant or adverse electrical interference. For example, in one embodiment, the electrochemical sensor of the present disclosure can take multiple and simultaneous measurements of chemical concentrations of different types of chemicals within the same sample of fluid. The fluid, for instance, may comprise pool water or a biological fluid, such as blood or urine.

In one embodiment, the present disclosure is directed to an electrochemical sensor that includes a support having a first side and a second an opposite side. At least one electrochemical cell is disposed on the first side of the support. The at least one electrochemical cell includes a reference electrode having an end that is contiguous with a first side and a second side of the electrode. The electrochemical cell also includes a working electrode spaced from the reference electrode. The working electrode also has an end that is contiguous with a first side and a second side of the electrode. The at least one electrochemical cell further includes a counter electrode. The counter electrode has a shape that defines an electrode receiving area. For instance, in one embodiment, the counter electrode can have a U-shape that defines an electrode receiving area. The electrode receiving area surrounds the first side, the second side, and the end of the reference electrode and the working electrode. In this manner, the counter electrode itself is used to prevent electrical interference during the taking of measurements.

The spacing between the different electrodes can vary depending upon the particular application. In one embodiment, for instance, the working electrode and the reference electrode are spaced closer together in relation to the spacing between the working electrode and the reference electrode to the counter electrode. As used herein, the spacing is measured from a side edge of an electrode to a side edge of an adjacent electrode. In one embodiment, the distance between the counter electrode and the working electrode and/or reference electrode is greater than the distance between the working electrode and the reference electrode. For example, the distance between the counter electrode and the other electrodes can be up to 5 times greater than the distance between the working electrode and the reference electrode. For instance, the distance between the counter electrode and one of the other electrodes can be from about 1.2 to about 3 times greater, such as from about 1.6 to about 2.4 times greater, such as from about 1.9 to about 2.1 times greater than the distance between the working electrode and the reference electrode.

In order to detect an analyte in a fluid, the electrochemical sensor further includes a reagent composition associated with the working electrode. For instance, the reagent composition can be coated onto the working electrode or can be added to the fluid sample. The reagent composition is configured to sense the presence of an analyte in a fluid being tested. For instance, in one embodiment, the reagent composition is formulated to form a current when contacted with an analyte in the fluid being tested when a voltage difference is applied between the reference electrode and the working electrode.

In one embodiment, the electrochemical sensor can have a single electrochemical cell. In an alternative embodiment, the electrochemical sensor can comprise a plurality of electrochemical cells disposed on the first side of the support. Of particular advantage, the plurality of electrochemical cells can be operated simultaneously to detect the presence of one or more analytes in a fluid without one of the electrochemical cells causing electrical interference in an adjoining electrochemical cell. For instance, when a plurality of electrochemical cells are disposed on a support, each electrochemical cell can include a reference electrode and a working electrode. The counter electrode, however, can comprise a common counter electrode that can be used by each electrochemical cell. For instance, the common counter electrode can define a plurality of electrode receiving areas. Each electrode receiving area can have a U-shape. The reference electrode and the working electrode of each individual electrochemical cell can be positioned within a corresponding electrode receiving area on the common counter electrode. The common counter electrode can be maintained at a common potential voltage. For instance, the common counter electrode can comprise a grounded electrode. In accordance with the present disclosure, a voltage difference is applied between the working electrode and the reference electrode of each electrochemical cell for sensing the presence of an analyte. In order to detect the presence of an analyte, each working electrode of each electrochemical cell can be associated with a reagent composition. The reagent composition can be the same for each working electrode for detecting the same analyte or can be different for detecting different analytes. Analyte measurements can all be made simultaneously with the sensor of the present disclosure.

In one embodiment, the electrochemical sensor can include a plurality of electrochemical cells for simultaneously detecting the concentration of analytes in pool water. For example, in one embodiment, the first electrochemical cell may include a first reagent composition associated with the working electrode for indicating the alkalinity of a fluid contacting the electrochemical sensor. The electrochemical sensor can further include a second reagent composition associated with the working electrode of a second electrochemical cell that indicates the chlorine concentration in a fluid contacting the electrochemical cell. For instance, the reagent composition can be designed to detect free available chlorine or total available chlorine.

In other embodiments, the electrochemical sensor can include further electrochemical cells for detecting further analytes in pool water such as copper, borate, bromine, iron, and/or hardness such as calcium. A different reagent composition can be associated with the different working electrodes for sensing the different analytes. For instance, in one embodiment, a third reagent composition can be associated with the working electrode of a third electrochemical cell and a fourth reagent composition can be associated with the working electrode of a fourth electrochemical cell. The third reagent composition can, for instance, detect copper concentration while the fourth reagent composition can detect hardness, such as calcium.

In one embodiment, when the electrochemical sensor contains a plurality of electrochemical cells, the plurality of electrochemical cells can include at least one terminal electrochemical cell positioned at an end. The terminal electrochemical cell can include a reference electrode and a working electrode and can share the common counter electrode with the remainder of the plurality of electrochemical cells. Because the terminal electrochemical cell is positioned at the end of the plurality of cells, however, the counter electrode may not need to have an electrode receiving area or a U-shape. Instead, the counter electrode can be located only on one side of the reference electrode and the working electrode of the terminal electrochemical cell.

In addition to one or more terminal electrochemical cells, the electrochemical sensor can also include an isolated electrochemical cell that is galvanically isolated from the plurality of electrochemical cells. The isolated electrochemical cell can include a reference electrode, a working electrode, and a counter electrode that is separate from the common counter electrode. One or more electrochemical cells can be isolated from the remainder of the cells for various reasons and to further prevent electrical interference. When testing pool water, for instance, the isolated electrochemical cell may include a reagent composition associated with the working electrode that serves as an indicator for cyanuric acid. Various different boundaries can be used in order to isolate an electrochemical cell from the remainder of the cells on the strip. In one embodiment, for instance, the support can define a slot that separates the isolated electrochemical cell from the plurality of electrochemical cells.

Each of the electrodes on the electrochemical sensor, in one embodiment, can be associated with a corresponding electrical contact. Each electrode can be electrically connected to a separate contact. For example, in one embodiment, the plurality of electrical contacts can be disposed along one edge of the support while the plurality of electrodes can be disposed along a separate edge of the support. In one embodiment, an insulating strip can extend over portions of the electrodes in between the electrodes and the electrical contacts.

The present disclosure is also directed to an apparatus for measuring analytes in a fluid. The apparatus includes a reservoir for holding a fluid and a holding device for receiving the electrochemical sensor as described above. The apparatus can further include an analyzing device that electrically connects to the electrodes on the electrochemical sensor. The analyzing device can be configured to apply a common potential voltage to the common counter electrode and to control voltage differences between each pair of working electrode and reference electrode of each electrochemical cell for simultaneously measuring one or more analytes in a fluid loaded into the fluid reservoir.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a plan view of one embodiment of an electrochemical sensor made in accordance with the present disclosure;

FIG. 2 is a plan view of another embodiment of an electrochemical sensor made in accordance with the present disclosure;

FIG. 3 is a plan view of still another embodiment of an electrochemical sensor made in accordance with the present disclosure including a plurality of electrochemical cells, one terminal electrochemical cell, and one isolated electrochemical cell;

FIG. 4 is another view of an electrochemical sensor shown in FIG. 3 illustrating one embodiment of an electrode construction;

FIG. 5 depicts a diagram of an example of a conventional potentiostat circuit utilizing isolated counter electrodes;

FIG. 6 depicts a diagram of a non-conventional potentiostat circuit utilizing a grounded common counter electrode according to example embodiments of the present disclosure; and

FIG. 7 depicts an electrical schematic of a non-conventional potentiostat circuit according to example embodiments of the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to an electrochemical sensor for sensing an analyte, such as an atom, compound, molecule, oligomer, polymer, etc., in a fluid, such as a liquid or gas. In one embodiment, the electrochemical sensor of the present disclosure can include a single electrochemical cell for measuring the concentration of a single analyte. In an alternative embodiment, however, the electrochemical sensor can include a plurality of electrochemical cells which permit simultaneous sensing of concentrations of the same or different analytes within a fluid. For example, in one embodiment, the electrochemical sensor can include from about 2 to about 20, such as from about 3 to about 12 electrochemical cells, wherein each cell is configured to measure a different analyte in the same sample of fluid that may be contained in an uncompartmented reservoir. Of particular advantage as will be described in greater detail below, at least a subset of the electrochemical cells can perform simultaneous measurements without the need for galvanic isolation.

In the past, problems were experienced in attempting to take simultaneous measurements of different analytes in a liquid substance using the same electrochemical device. Liquid substances, for instance, have non-zero volumetric electrical resistances. When attempting to take multiple measurements simultaneously from the same liquid sample at different voltages and currents, the three dimensional electrical resistance of a liquid substance can cause undesirable mixing of electrical currents between adjacently located electrochemical cells thereby rendering invalid assay measurements. The electrochemical sensor of the present disclosure, however, prevents electrical cross current contamination by rearranging the electrical control and operation of the electrochemical cells such that current flow between adjacent cells does not cause measurement errors. More particularly, in accordance with the present disclosure, a plurality of electrochemical cells share a common counter electrode that, in one embodiment, surround the other working electrodes in each individual electrochemical cell. In accordance with the present disclosure, the common counter electrode can be held at a common potential voltage thereby minimizing electrical interference between the different adjacent cells. Thus, electrochemical cells made according to the present disclosure operate by controlling a voltage difference between a working electrode and a reference electrode while maintaining the counter electrode at a common potential voltage.

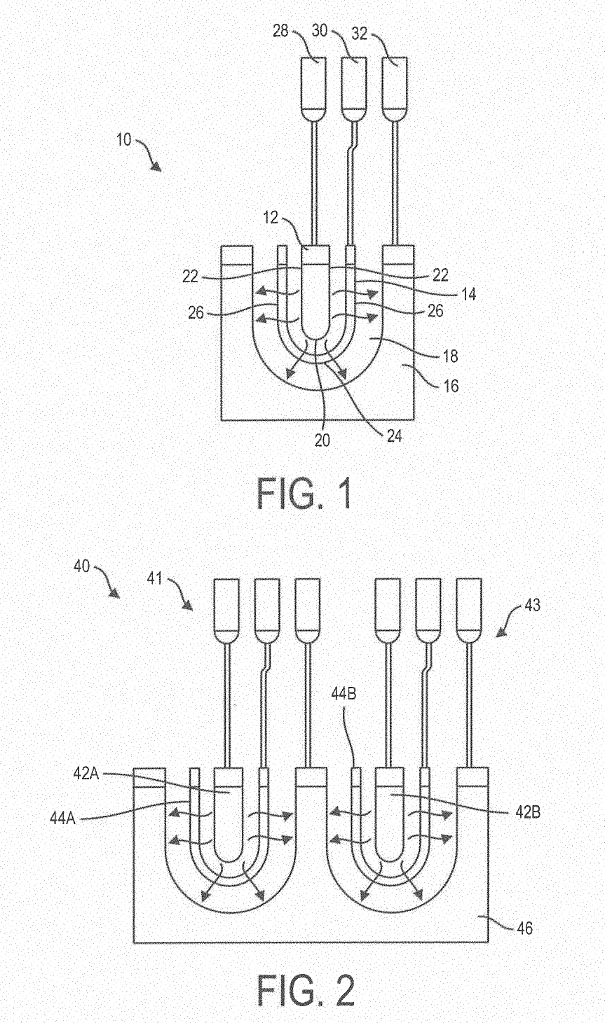

Electrochemical sensors made in accordance with the present disclosure can include a single electrochemical cell or can comprise a plurality of electrochemical cells. Referring to FIG. 1, an electrochemical device 10 is illustrated that includes only a single electrochemical cell. As shown, the electrochemical device 10 includes a working electrode 12 spaced from a reference electrode 14. In accordance with the present disclosure, the electrochemical device 10 further includes a counter electrode 16. As shown in FIG. 1, the counter electrode 16 has a U-shape that forms an electrode receiving area 18. The working electrode 12 and the reference electrode 14 are inserted into the electrode receiving area 18.

For instance, the working electrode 12 can include an end 20 contiguous with two opposing sides 22 and 22′. The reference electrode 14 includes an end 24 and opposing sides 26 and 26′. As shown, the walls of the counter electrode surround the end and the sides of both the working electrode 12 and the reference electrode 14. In this manner, the counter electrode not only assists in measuring for analytes but also serves to minimize any electronic interference.

In the embodiment illustrated in FIG. 1, the reference electrode 14 has a U-shape for surrounding the working electrode 12. In other embodiments, however, the working electrode 12 and the reference electrode 14 can be positioned in a side by side relationship.

As shown in FIG. 1, in one embodiment, the working electrode 12 and the reference electrode 13 can be spaced closer together than the distance between the reference electrode 14 and the counter electrode 16. For example, the distance between the counter electrode 16 and the reference electrode 14 can be from about 1 to about 5 times, such as from about 1.2 to about 3 times, such as from about 1.6 to about 2.4 times, such as from about 1.9 to about 2.1 times greater than the distance between the reference electrode 14 and the working electrode 12.

Each of the electrodes can also include an electrical contact for connecting the electrochemical device 10 to a controller for controlling voltages and taking measurements. For example, the working electrode 12 is electrically connected to the electrical contact 28. The reference electrode 14 is electrically connected to the electrical contact 30 while the counter electrode 16 is electrically connected to the electrical contact 32.

The electrodes 12, 14 and 16 can generally be made from any suitable conductive material. For instance, the electrodes can be made from gold, silver, platinum, conductive carbon, a conductive polymer, compounds thereof, and mixtures thereof. Similarly, the electrical connectors 28, 30 and 32 can also be made from any suitable conductive material, such as any of the materials described above. The electrical contacts 28, 30 and 32 can be made from the same material or from a different material than the corresponding electrodes 12, 14 and 16.

In order to sense the presence of an analyte, the working electrode 12 can be associated with a reagent composition. The reagent composition can be formulated to create a current as shown by the arrows in FIG. 1 when a fluid containing the analyte is contacted with the electrodes. For example, in one embodiment, the reagent composition can comprise a coating applied to the working electrode 12. The reagent composition can coat the entire surface area of the working electrode 12 or can coat only a portion of the surface area of the working electrode.

The reagent composition used in the electrochemical device can generally comprise any suitable reagent composition for detecting any analyte that may be desired. For example, in one embodiment, the electrochemical device can be used to measure the concentration of an analyte in a biological fluid, such as blood or urine. In one particular embodiment, the reagent composition can be used to measure the concentration of glucose in blood. For example, in one embodiment, the reagent composition may comprise glucose oxidase enzyme for detecting the concentration of glucose in a fluid. In an alternative embodiment, glucose can be sensed using a non-enzymatic composition. For example, in one embodiment, the working electrode 12 may be covered by a membrane that is sized to keep larger molecules, such as those having a molecular weight greater than 100,000, from passing through. The membrane, for instance, can filter out proteins and lipids while allowing glucose to pass. The membrane, for instance, can be made from cellulose esters, nylon, polyvinyl fluoride, polytetrafluoroethylene, cellulose nitrate, acetate, and mixtures thereof. The reagent composition that detects the presence of glucose, on the other hand, may comprise a coating of tin oxide or tin dioxide that comprises the working electrode 12. In this embodiment, glucose passing through the membrane undergoes an oxidation reaction under applied positive voltage which then allows for a concentration measurement to be taken.

In other embodiments, a reagent composition can be used for detecting an analyte contained in pool water, which includes spa water. Analytes that may be measured in pool water include for instance, free chlorine, total chlorine, calcium hardness, copper, total alkalinity, cyanuric acid, and the like.

In order to operate the electrochemical device 10 as shown in FIG. 1, the counter electrode 16 can be held at a common potential voltage and may comprise, for instance, a circuit ground. Having the counter electrode be at a common potential voltage prevents electrical currents from penetrating the counter electrode and creating interference when taking a measurement. In the electrochemical device as shown in FIG. 1, for instance, the voltage can be varied between the working electrode 12 and the reference electrode 14. For example, a controller can alter and maintain the required specific voltage difference between the working electrode and the reference electrode.

In one embodiment, for instance, the working electrode 12 is an electrode where the potential is controlled and where the current is measured. The working electrode serves as a surface on which an electrochemical reaction takes place. A controller maintains the potential difference between the reference electrode and the working electrode to be equal to a user supplied input control potential required for analysis of any specific reagent composition. The counter electrode, on the other hand, is a conductor that completes the cell circuit. Current flowing into the sample fluid via the working electrode leaves the fluid via the counter electrode.

Referring now to FIG. 2, another electrochemical device 40 made in accordance with the present disclosure is shown. The electrochemical device 40 is similar to the electrochemical device 10 as shown in FIG. 1. The electrochemical device 40, however, includes a plurality of electrochemical cells. In the embodiment illustrated, for instance, the electrochemical device 40 includes a first electrochemical cell 41 and a second electrochemical cell 43.

The spacing between the working electrode 42 and the reference electrode 44 and the spacing between the counter electrode 46 and the reference electrodes 44A and 44B can be the same as described above with respect to FIG. 1. For instance, the counter electrode 46 can be spaced a farther distance from the reference electrodes 44A and 44B in relation to the space between the working electrode 42 and the reference electrode 44.

The first electrochemical cell 41 includes a working electrode 42A spaced from a reference electrode 44A. The second electrochemical cell 43, on the other hand, includes a working electrode 42B spaced from a reference electrode 44B. In accordance with the present disclosure, the electrochemical device 10 includes a common counter electrode 46. As shown, the counter electrode 46 is a continuous structure that surrounds the electrodes of the first electrochemical cell 41 and surrounds the electrodes of the second electrochemical cell 43.

As shown in FIG. 2, the first electrochemical cell 41 and the second electrochemical cell 43 share the common counter electrode 46 which, in one embodiment, is held at a common potential voltage, such as at circuit ground. In this manner, current from the working electrodes 42A and 42B are prevented from interfering with the adjacent electrochemical cell. The electrical current generated by each cell can then be easily measured across a resistor placed in series with a corresponding working electrode when a desired voltage difference is maintained between the working electrode and the reference electrode. Consequently, multiple and simultaneous measurements of a fluid can occur. More particularly, the electrochemical device 40 as shown in FIG. 2 is capable of simultaneously sensing the concentrations of the same or different analytes within a fluid, such as a liquid, by simply submerging the electrochemical device 40 within a sample of the fluid.

In order to measure an analyte, the working electrodes 42A and 42B can be placed in association with a reagent composition. The reagent composition can comprise, for instance, a coating on the electrode, a material that is incorporated into the electrode and/or a composition added to the test sample.

In one embodiment, the working electrodes 42A and 42B can be associated with the same reagent composition for taking two measurements of the same analyte in a fluid sample. For example, duel measurements may be taken in order to improve accuracy and detect any measurement errors. For example, in one embodiment, both working electrodes 42A and 42B can be associated with a reagent composition designed to detect glucose in a fluid such as a body fluid.

Alternatively, each working electrode 42A and 42B can be associated with a different reagent composition for simultaneously sensing the concentration of two different analytes in a fluid sample. For example, in one embodiment, the electrochemical device 10 may be used to sense and monitor two different analytes in pool or spa water. For instance, working electrode 42A can be associated with a reagent composition for detecting alkalinity while reference electrode 42B can be associated with a reagent composition for detecting chlorine concentration.

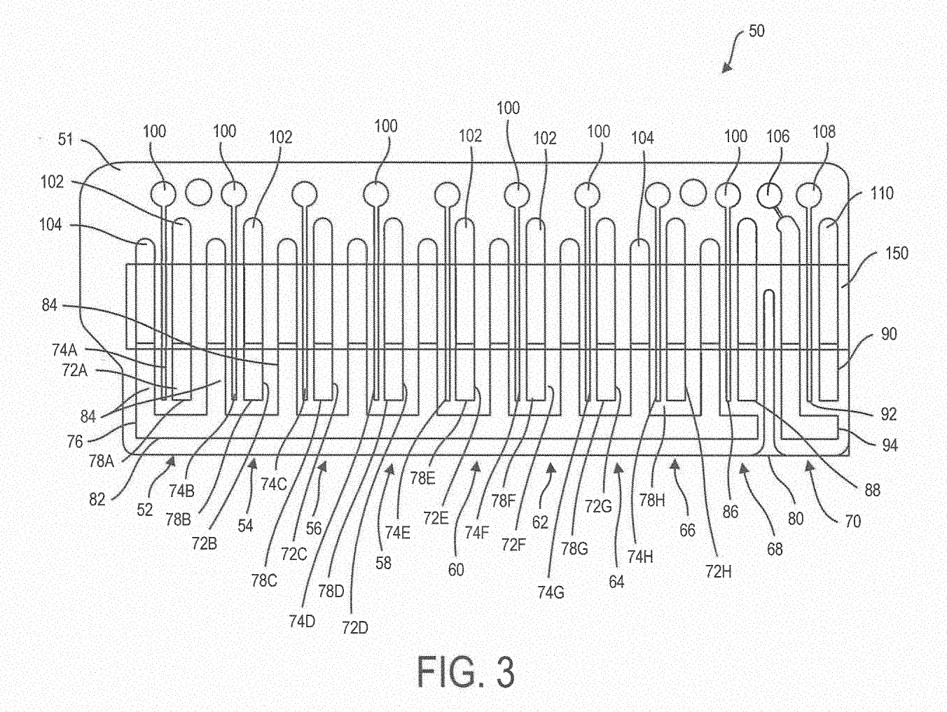

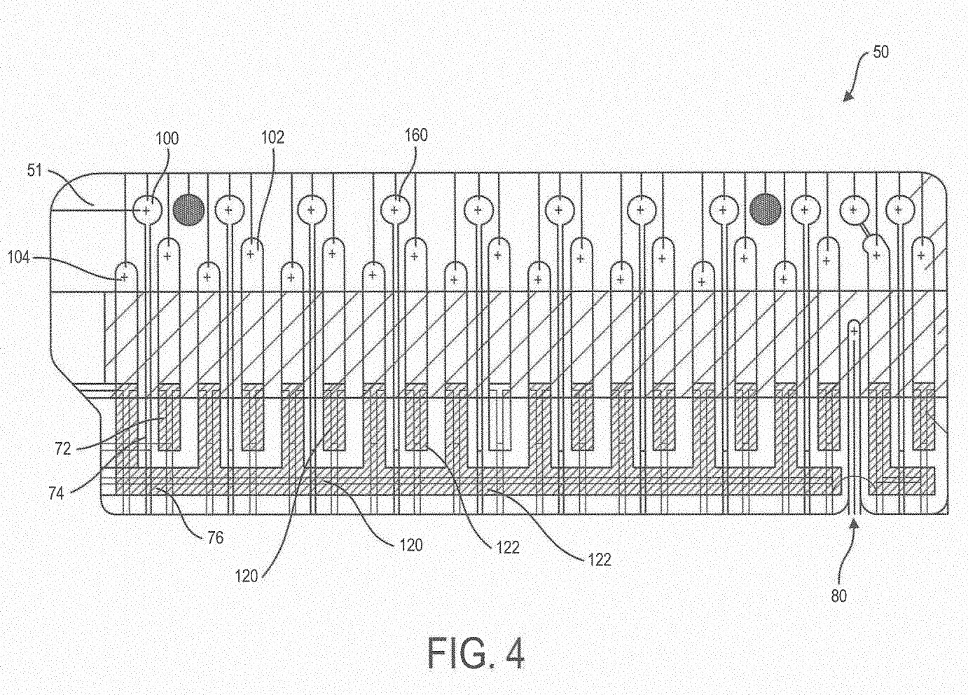

Referring now to FIGS. 3 and 4, another embodiment of an electrochemical device 50 made in accordance with the present disclosure is shown. The electrochemical device 50 includes a support 51, which may comprise a film, that has disposed on one side a plurality of electrochemical cells. For example, in the embodiment illustrated in FIGS. 3 and 4, the electrochemical device 50 includes ten electrochemical cells 52, 54, 56, 58, 60, 62, 64, 66, 68 and 70 for taking ten separate measurements simultaneously when the electrochemical device 50 is contacted with a fluid sample.

In general, the support 51 is formed from a material which is electrically non-conductive and inert to the testing environment and chemicals applied thereto. As described above, in one embodiment, the support 51 comprises a film, such as a flexible film. The film can be made from any suitable material, such as ceramic, paper, glass, or a polymer. When formed from a polymer, the film can be made from any suitable non-conductive material, such as polyester, polycarbonate, polyvinylchloride, or a polyolefin such as polyethylene or polypropylene.

In one embodiment, the electrochemical cells disposed on the support 51 are applied to the support through a printing process. For instance, the electrodes, electrical contacts, and insulating layers can all be made from compositions that can be printed on to the substrate. For example, the different materials can be applied to the support 51 using screen printing, lithography, vapor deposition, spray coating, vacuum deposition, inkjet printing, and combinations thereof.

Various different conductive compositions, such as conductive inks, are available that can be applied to the support 51. The conductive composition, for instance, can contain metal ions or a conductive metal compound. In addition, carbon base materials are available that are also highly conductive. Metals that can be contained in the composition include gold, silver, platinum, and/or conductive noble metals. For example, in one embodiment, silver chloride may be used to produce the electrodes or any other conductive parts of the electrochemical device 50.

As shown in FIG. 3, the electrochemical device 50 includes ten different electrochemical cells. Electrochemical cells 52, 54, 56, 58, 60, 62, 64 and 66 form a plurality of electrochemical cells that have a similar configuration. In addition, the electrochemical device 50 includes a terminal electrochemical cell 68 and an isolated electrochemical cell 70. Electrochemical cell 70, for instance, can be electrically isolated from the remainder of the electrochemical cells using any suitable insulating barrier. In the embodiment illustrated in FIGS. 3 and 4 for instance, the isolated electrochemical cell 70 is isolated from the remainder of the electrochemical cells by a slot 80 formed into the support 51.

Electrochemical cells 52, 54, 56, 58, 60, 62, 64 and 66 each include a working electrode 72A, 72B, 72C, 72D, 72E, 72F, 72G, and 72H, and a reference electrode 74A, 74B, 74C, 74D, 74E, 74F, 74G, and 74H. The working electrode 72 is spaced from the reference electrode 74. During operation of the electrochemical device, an analyzing device can be electrically connected to each of the electrodes and can apply a voltage difference between the working electrode 72 and the reference electrode 74. The voltage difference can be the same within each electrochemical cell or can be different. In one embodiment, for instance, an analyzer can be programmed to apply a different voltage difference between the working electrode and the reference electrode depending upon the analyte being measured. For example, the voltage difference between the reference electrode and the working electrode can be less than about ^{+/-}0.1 volts, such as less than about ^{+/-}0.3 volts, such as less than about ^{+/-}0.5 volts, such as less than about ^{+/-}0.7 volts, such as less than about ^{+/-}1 volts, such as less than about ^{+/-}1.2 volts, such as less than about ^{+/-}1.5 volts, such as less than about ^{+/-}1.7 volts, such as less than about ^{+/-}2 volts, such as less than about ^{+/-}2.5 volts, such as less than about ^{+/-}3 volts. The difference is generally greater than ^{+/-}20 volts, such as greater than about ^{+/-}10 volts, such as greater than about ^{+/-}5 volts. For example, in another embodiment, the difference between the reference electrode and the working electrode can exist anywhere within a range of +2.0 volts to −2.0 volts depending on the electrochemical characteristics of the particular analyte and testing being performed. The voltage difference, however, can vary and fall outside the above ranges depending upon the particular application and the desired result.

In accordance with the present disclosure, electrochemical cells 52, 54, 56, 58, 60, 62, 64 and 66 include a common counter electrode 76. As shown in FIG. 3, the common counter electrode 76 can comprise a continuous structure and can include a common base electrode portion 82 connected to vertical arm portions 84. In this manner, the common counter electrode 76 has a U-shaped structure associated with each electrochemical cell and forms electrode receiving areas 78A, 78B, 78C, 78D, 78E, 78F, 78G, and 78H. The electrode receiving areas 78 surround on three sides the working electrodes 72 and the reference electrodes 74 contained in each of the electrochemical cells. By surrounding the working electrode and reference electrode of each of electrochemical cell and by being maintained at a common potential voltage during operation, the counter electrode 76 not only has utility in providing analyte measurements but also prevents against electrical interference from the adjacent cells.

Similar to the other embodiments, in one embodiment, the distance between the counter electrode 76 and the working electrode 72 or the reference electrode 74 is greater than the distance between the working electrode 72 and the reference electrode 74. For example, in the embodiment illustrated in FIG. 3, the distance between the counter electrode 76 and the working electrode 72 can be from about 1 to about 5 times greater, such as from about 1.2 to about 3 times greater, such as from about 1.6 to about 2.4 times greater, such as from about 1.9 to about 2.1 times greater than the distance between the working electrode 72 and the reference electrode 74. Similarly, the distance between the counter electrode 76 and the reference electrode 74 can also be from about 1 to about 5 times greater, such as from about 1.2 to about 3 times greater, such as from about 1.6 to about 2.4 times greater, such as from about 1.9 to about 2.1 times greater than the distance between the working electrode 72 and the reference electrode 74.

As shown in FIG. 3, the electrochemical device 50 also includes the terminal electrochemical cell 68 positioned at an end of the plurality of electrochemical cells 52, 54, 56, 58, 60, 62, 64 and 66. The electrochemical cell 68 includes a reference electrode 86 and a working electrode 88. Although the terminal electrochemical cell 68 utilizes the common counter electrode 76, the common counter electrode 76 does not surround on three sides the reference electrode 86 and the working electrode 88. By being located on the end of the plurality of electrochemical cells and by being located adjacent to the slot 80, it is not necessary for the counter electrode to completely surround the reference electrode 86 and the working electrode 88 in order to prevent against electrical interference.

In addition to the terminal electrochemical cell 68, the electrochemical device 50 further includes an isolated electrochemical cell 70. The isolated electrochemical cell 70 includes a working electrode 90, a reference electrode 92, and a separate counter electrode 94. In some instance, it may be desirable to include an electrochemical cell with the electrochemical device 50 that is electrically isolated from the remainder of the electrochemical cells. For instance, the isolated electrochemical cell 70 may generate strong electrical currents that can interfere with the other electrochemical cells or may be highly sensitive to any electronic interference. By including the slot 80 or any other type of electrical insulating barrier, the electrochemical device 50 can include an isolated electrochemical cell 70 in order to further measure other analytes in the sample fluid.

In one embodiment, the electrochemical cell 50 as shown in FIGS. 3 and 4 can be used to simultaneously measure different analytes in a sample of pool or spa water. For example, the ten electrochemical cells can be used to measure Total Dissolved Solids (TDS), copper, borate, bromine, iron, total alkalinity, total chlorine, free chlorine, calcium hardness, hydrogen peroxide and cyanuric acid in a fluid sample simultaneously. In one embodiment, each of the electrochemical cells can be placed in association with a different reagent for measuring each of the different analytes. One of the electrochemical cells, however, may not need a reagent for measuring a particular analyte. For instance, total dissolved solids can be measured using a blank sensor with no reagent.

Chlorine levels in pool water, for instance, can be important for disinfecting or sanitizing the water by destroying microorganisms, such as bacteria, fungi, viruses, and algae. Pool water is typically measured for free chlorine and total chlorine. Free chlorine generally refers to the concentration of Cl₂, HOCl, or OCl⁻. Total chlorine, on the other hand, is the sum of free available chlorine and combined available chlorine. Combined available chlorine refers to chlorine species associated with inorganic chloramines and organic chloramines in water.

In order to maintain pH in a desired range, total alkalinity can be measured in pool water. Total alkalinity is a measure of the buffering capacity of the water to resist pH change. Total alkalinity can be measured by measuring the amount of carbonate and bicarbonate in the sample.

Total hardness or calcium hardness is the measure of water hardness. Calcium and magnesium ions are the primary sources of water hardness. High calcium hardness can result in cloudy water and scale formation while low calcium levels can lead to corrosion.

Cyanuric acid levels in pool water can be important in order to stabilize free available chlorine in the water. Cyanuric acid, for instance, can protect free available chlorine against UV light degradation.

In addition to the above, various other analytes can be measured in pool water including bromine, iron and copper. Bromine serves as a sanitizer. Iron and copper, on the other hand, can be monitored in order to prevent against increased levels that can result in staining and high sanitizer consumption.

When the electrochemical device 50 as shown in FIGS. 3 and 4 is used to measure analytes in pool water, most of the working electrodes 72 can be associated with a different reagent composition for measuring a different analyte in the pool water sample. In other embodiments, various different electrochemical cells can be used to measure the same analyte as a way to ensure accuracy. The reagent compositions, in one embodiment, can be applied to the working electrode as a coating or can be combined with the conductive composition that is used to form the electrode.

Reagent compositions that can be applied to the working electrodes in accordance with the present disclosure are as follows.

Free Chlorine Detection Reagent Composition

The free chlorine reagent composition for the free chorine electrochemical sensor according to the invention, measures the content of free chlorine in water by the amperometric analysis. The reagent composition for the free chlorine electrochemical sensor will generally contain a redox indicator reagent, a buffer and a polymeric material. Typically, water is used as the solvent for the composition and the components are added so that the resulting composition has the component present in an amount disclosed below. These components are generally mixed and applied to the second surface of the working electrode. The solvent is removed by drying the composition at an elevated temperature for a period of time.

Suitable redox indicator reagents include, for example p-phenylenediamine salts, N,N-diethyl-p-phenylenediamine sulfate salt (DPD), N,N-dimethyl-p-phenylenediamine sulfate salt, and N,N,N′N′-tetramethyl-p-phenylenediamine. The redox indicator reagent component is added to the reagent composition to form a solution which is about 0.01 M to about 0.20 M, and more typically in a 0.03 to about a 0.07 M.

Suitable buffers include phthalate buffers, phosphate buffers. Phosphate buffers include, for example disodium hydrogen phosphate, sodium di-hydrogen phosphate, and mixtures thereof. The buffer component is generally present in the reagent composition in the range of about 0.01 to about 0.03 M.

Sodium chloride is generally added to the buffer in a concentration of about 0.3 to about 0.6 M. Typically, it is added in an amount of about 0.4 to about 0.5 M.

In addition, the reagent composition will also have a polymeric component added to assist disposition of the redox indicator reagent to the surface of the electrode. In addition, the polymeric material in the reagent composition is used to retain reagent and buffer mixture on the electrode surface, and stabilizing the response of electrochemical detection. Possible polymers include, for example, polyethylene glycol, sodium alginate, polyvinyl alcohol, or other similar polyelectrolyte polymers. Generally, polyethylene glycol is used for the free chlorine sensor. Typically, the polymer is added in an amount of about 0.1 to about 2.0% by weight, based on the volume of the solution.

In the electrochemical sensor containing a free chlorine reagent composition applied to the working electrode, the amount of free chlorine is measured by generating a voltage, such as a desired voltage or user selected voltage, applied between the reference electrode and the working electrode, and the resulting current from the working electrode is measured, according to the reaction shown below:

HOCl+2eχCl⁻+OH⁻

The sensor is polarized at a potential value (vs Ag/AgCl) for a time period. The current observed at 15-30 seconds is averaged using the software embedded in the potentiostat. The concentration of free chlorine is then determined using the average current value and the pre-loaded calibration table in the instrument.

The reagent used for measuring free chlorine can also be used in a similar manner to measure bromine.

Total Chlorine Detection Reagent Composition

The total chlorine reagent composition for the total chorine electrochemical sensor according to the invention, measures the content of total chlorine in water by the amperometric analysis. The reagent composition for the total chlorine electrochemical sensor will generally contain a potassium halide salt, a buffer component and a polymeric material. Typically, deionized water is used as the solvent for the composition and the components are added so that the resulting composition has the component present in an amount disclosed below. These components are generally mixed and applied to the second surface of the working electrode to form the total chlorine working electrode.

The potassium halide salt added to the reagent composition may be potassium bromide, and potassium chloride. Generally, the potassium salt is added in an amount such that the potassium salt is present in a concentration of about of 0.05 to 2M typically about 0.25 to about 0.75 M. One specific example is a 0.5M concentration of potassium bromide.

Suitable buffers include phthalate buffers, phosphate buffers. Phosphate buffers include, for example disodium hydrogen phosphate, sodium di-hydrogen phosphate and mixtures thereof. Suitable phthalate buffers include potassium hydrogen phthalate. The buffer component is generally present in the reagent composition in the range of about 0.01 to about 0.3 M. The pH of the buffer solution should be adjusted to the range around 4-5 pH is generally adjusted using a diluted hydrochloric acid (HCl), such as 0.1 M HCl.

In addition, the reagent composition will also have a polymeric component added to assist disposition of the potassium salt and buffer to the surface of the electrode. In addition, the polymeric material in the reagent composition is used to retain reagent and buffer mixture on the electrode surface, and stabilizing the response of electrochemical detection. Possible polymers include, for example, polyvinyl alcohol, sodium alginate, or other similar polyelectrolyte polymers. Generally, sodium alginate is used for the total chlorine sensor. Typically, the polymer is added in an amount of about 0.1 to about 2.0% by weight, based on the weight of the solution.

Total chlorine is measured amperometically by applying a voltage to the working electrode and measuring the current from the working electrode. Combined chlorine is then determined by difference between the total chlorine and free chlorine contents. Potassium bromide can react with free chlorine and combined chlorine as follows:

OCl⁻+2Br⁻+2H⁺↔Br₂+Cl⁻+H₂O

Cl₂+2Br⁻↔Br₂+2Cl⁻

NH₂Cl+2Br⁻+2H⁺↔Br₂+Cl⁻+NH₄⁺

RNHCl+2Br⁻+2H⁺↔Br₂+Cl⁻+RNH₃⁺

The liberated bromine is reduced electrochemically at the electrode as shown below:

Br₂+2e⁻↔2Br⁻

Calcium Hardness Detection Reagent Composition

The calcium hardness sensor according to the invention measures the content of calcium ion in water by the amperometric analysis. The reagent used in the calcium hardness reagent composition is an electrochemical indicator for the detection of calcium ion and other complexometric indicators. The reagent composition for the hardness electrochemical sensor will generally contain an electrochemical indicator for the detection of calcium ion and other complexometric indicators, a buffer component and a polymeric material. Typically, deionized water is used as the solvent for the composition and the components are added so that the resulting composition has the component present in an amount disclosed below.

The electrochemical indicator for the detection of calcium ion and other complexometric indicators are generally present in the reagent composition in an amount in the range of about 1 to 10 mM, typically about 2-4 mM. Suitable compounds for this component include Alizarin Red, Alizarin Yellow CG, Alizarin Green, Alizarin Blue Black B, and Eriochrome Black T. Of these, Alizarin Red S (3,4-dihydroxy-9,10-dioxo-2-anthracenesulfonic acid sodium salt) is typically used as an electrochemical indicator for the detection of calcium ion.

Suitable buffers include phthalate buffers, phosphate buffers and an acetate buffer. Phosphate buffers include, for example disodium hydrogen phosphate, sodium di-hydrogen phosphate and mixtures thereof. Suitable phthalate buffers include potassium hydrogen phthalate. The buffer component is generally present in the reagent composition in the range of about 0.01 to about 0.3 M. The pH of the buffer solution should be adjusted to the range around 3-4 pH is generally adjusted using a diluted hydrochloric acid (HCl), such as 0.1M HCl.

In addition, the reagent composition will also have a polymeric component added to assist disposition of the Alizarin Red S, and buffer to the surface of the electrode. In addition, the polymeric material in the reagent composition is used to retain reagent and buffer mixture on the electrode surface, and stabilizing the response of electrochemical detection. Possible polymers include, for example, polyvinyl alcohol, polyvinylpyrrolidone, sodium alginate, or other similar polyelectrolyte polymers. Generally, polyvinyl alcohol or polyethylene oxide is used for the calcium hardness sensor. Typically, the polymer is added in an amount of about 0.05 to about 5.0% by weight, based on the weight of the solution. More preferably, the polymer is added in an amount of about 1.5 to 3% by weight, based on the weight of the solution.

Suitable buffers include phthalate buffer, phosphate buffer, and acetate buffer in a pH range of 3.0 to 4.0. Suitable polymer materials may include, but not limited to sodium alginate, polyvinyl alcohol, polyvinylpyrrolidone, polyethylene oxide or other polyelectrolytes.

In another embodiment, the calcium hardness reagent is a copper (II) ions pre-loaded into a cationic ion exchange resin in lieu of a buffer and alizarine Red S. The copper loaded resin is combined with a polymeric material, as described above, to prepare the reagent composition.

In another embodiment, the measurement of calcium ions in water is made by the electrochemical detection of copper (II) ion that is released from cation exchange resin via ion exchange reaction. Copper salts in anhydrous or hydrated form are used as the source of copper (II) ions. Possible copper (II) salts include, but are not limited to, copper sulfate, copper chloride and copper nitrate. Copper (II)-bounded cation exchange resin is prepared by soaking the resin in appropriate copper salt solution, drying the treated resin. The exchange resin is then mixed with a polymeric binder in water, as described above, to prepare the reagent composition. The water is then evaporated with heat to deposit the resin and polymer on top of the electrode.

Suitable cation exchange resins include cation exchange resins commonly made of styrene and cross-linking agent divinyl benzene, which are post-functionalized to contain sulfonic acid groups, carboxylic acid groups, or their corresponding salts. Suitable cation exchange resins used to prepare the calcium hardness sensor include cation exchange resins sold under the trade names Amberlite®, Amberlist®, Dowex®, Duolite® that bear sulfonic acid or carboxylic acid groups, or their corresponding Na⁺ or H⁺ salt form.

Total Alkalinity Detection Reagent Composition

The total alkalinity sensor according to the invention measures the contents of carbonate and bicarbonate in water by the amperometric analysis using manganese compound as the reagent. Suitable manganese compounds include, for example, manganese (II) salts, including but not limited to manganese perchlorate, manganese acetate, manganese chloride, manganese nitrate, manganese sulfate. Typically, the reagent composition manganese (II) perchlorate as the reagent and a polymeric material. The manganese (II) perchlorate reagent is generally present in a concentration of 5 to 100 mM, typically between about 20 to 40 mM.

In addition, the reagent composition will also have a polymeric component added to assist disposition of the manganese (II) perchlorate to the surface of the electrode. In addition, the polymeric material in the reagent composition is used to retain reagent on the electrode surface, and stabilize the response of electrochemical detection. Possible polymers include, for example, polyvinyl alcohol, polyvinylpyrrolidone, sodium alginate, polyethylene oxide or other similar polyelectrolyte polymers. Generally, polyvinylpyrrolidone is used for the total alkalinity sensor. Generally, the polymer is added in an amount of about 0.5 to about 5.0% by weight, based on the volume of the solution. Typically the polymeric component will be about 1.5 to about 3% by weight of the composition.

Mn²⁺ ions complex with bicarbonate ions at a desirable pH range of 7.2-7.6 in pool water as shown below:

Mn²⁺(aq)+2HCO₃⁻↔[Mn(HCO₃)₂]

The Mn-bicarbonate complex is then oxidized electrochemically at the electrode as shown below:

[Mn(HCO₃)₂]↔Mn³⁺+2HCO₃⁻+e⁻

Cyanuric Acid Detection Reagent Composition

The cyanuric acid sensor according to the invention measures the content of cyanuric acid in water by the amperometric analysis using copper (II) ions that can come from any compound or sources such as transition metal (II) salts which examples are, sulfates, nitrates, and chlorides salts. Typically, the reagent composition contains copper (II) ions coming from a typical 1000 ppm analytical copper solution standard in nitric acid as the reagent and a polymeric material. The copper (II) ion reagent is generally present in a concentration of 5 to 100 ppm (as Cu), typically between about 5 to 20 ppm.

The reagent composition has a polymeric component added to assist binding of the copper (II) to the surface of the working electrode. In addition, the polymeric material in the reagent composition is used to stabilize the response of electrochemical detection. Possible polymers include, for example, polyethylene glycol, polyvinyl alcohol, polyvinylpyrrolidone, or other similar polyelectrolyte polymers. Generally, polyvinyl alcohol is used to prepare the cyanuric acid sensor. Generally, the polymer is added in an amount of about 0.05 to about 5.0% by weight, based on the volume of the solution. Typically the polymeric component will be about 0.05 to about 1% by weight of the composition.

Copper Ion Detection Reagent Composition

The copper ion sensor according to the invention measures the copper content in water by squarewave voltammetry using a buffer deposited on the working electrode. Typically, the buffer has pH ranging from 3 to 4, such as 3.4. Suitable buffers, for example, include phthalate, phosphate, citrate and acetate buffers with phthalate buffers being preferred.

Borate Detection Reagent Composition

The borate sensor measures the content of borates in water by the amperometric analysis using a manganese compound as the reagent. Suitable manganese compounds include, for example, manganese (II) salts, including but not limited to manganese perchlorate, manganese acetate, manganese chloride, manganese nitrate, manganese sulfate. Typically, the reagent composition manganese (II) sulfate as the reagent and a polymeric material. The manganese (II) sulfate reagent is generally present in a concentration of 5 to 100 mM, typically between about 20 to 40 mM.

In addition, the reagent composition will also have a polymeric component added to assist disposition of the manganese (II) sulfate to the surface of the electrode. In addition, the polymeric material in the reagent composition is used to retain reagent on the electrode surface, and stabilize the response of electrochemical detection. Possible polymers include, for example, polyvinyl alcohol, polyvinylpyrrolidone, sodium alginate, polyethylene oxide or other similar polyelectrolyte polymers. Generally, polyvinylpyrrolidone is used for the borate sensor. Generally, the polymer is added in an amount of about 0.01 to about 5.0% by weight, based on the volume of the solution. Typically the polymeric component will be about 0.01 to about 0.08% by weight of the composition.

Iron Ion Detection Reagent Composition

In order to detect iron, an iron reagent can be placed into the water tray (as opposed to being directly applied to one or more electrodes). Iron ions, for instance, can be detected by using an iron reagent that contains primarily lactose monohydrate. The lactose monohydrate can be present in an amount from about 60% to about 90% by weight. In addition, the reagent composition can contain sodium chloride, sodium sulfate, sodium dithionite, sodium metabisulfite, and 2,2-biprydyl. The sodium metabisulfite can be present in the reagent composition in an amount from about 10% to about 15% by weight. The remaining ingredients can be present in an amount from about 1% to about 5% by weight.

Hydrogen Peroxide Detection Reagent Composition

In order to detect hydrogen peroxide, a hydrogen peroxide reagent composition can contain an iron compound, such as an iron (II) or iron (III) compound, such as hexacyanoferrate (II, III). For instance, in one embodiment, the hydrogen peroxide reagent composition may contain a polymer in combination with from about 0.5% to about 5% by weight of Prussian blue. The polymer can comprise any of the polymers described above with respect to the total alkalinity reagent. The polymer, for instance, can comprise polyvinyl alcohol.

Referring back to FIG. 3, during operation of the electrochemical device 50, an analyzing device can be electrically connected to each of the electrodes. In this regard, the electrochemical device 50 can include a plurality of electrical contacts for electrically connecting to each of the electrodes. For instance, each of the working electrodes 72 can include electrical contacts 102. Reference electrode 74, on the other hand, can include electrical contacts 100. Counter electrode 76 can include electrical contacts 104. In one embodiment, the common counter electrode 76 can include just a single electrical contact.

The isolated electrochemical sensor 70 can include its own electrical contact. For instance, working electrode 90 can include an electrical contact 110, reference electrode 92 can include an electrical contact 108, and counter electrode 94 can include an electrode contact 106. In the isolated electrochemical cell 70, the counter electrode 94 may not be held at a common potential voltage. By being isolated from the remainder of the electrochemical cells, for instance, a voltage can be applied to the counter electrode 94 using the electrical contact 106.

As described above, in one embodiment, the electrodes of the different electrochemical cells can be formed by applying one or more coatings to the support 51. Referring to FIG. 4, one embodiment of an electrode and electrical contact construction is shown.

In the embodiment illustrated in FIG. 4, for instance, the reference electrodes 74 and the electrical contacts 100 can be made from a conductive metallic composition applied to the support 51. For example, in one embodiment, the reference electrodes 74 including the electrical contacts 100 are made by applying a silver compound, such as silver chloride to the support.

The working electrode 72 and the counter electrode 76, on the other hand, can be made from multiple layers of materials. For example, the electrodes 72 and 76 can include a metallic trace layer 120 that can be applied first to the support 51. The metallic trace layer, for instance, may comprise a conductive silver, such as silver ions or a silver compound. The metallic trace layer 120 is then covered by a carbonized trace layer 122. As shown, the carbonized trace layer can have a width that is wider than the width of the metallic trace layer 120. In this manner, the carbonized trace layer 122 completely covers the metallic trace layer 120. The carbonized trace layer 122 can be made from any suitable conductive carbon source. For example, the carbonized trace layer 122 can be made from carbon black, graphite particles, or the like. A metallic trace layer, such as conductive silver underneath a carbonized layer, is used, at least in part, to lower the impedance of the conductors thus reducing any voltage potential gradients that can occur over the lengths of the conductors that become problematic when higher current is required for analyzing certain reagent compounds. Lower impedance traces can improve mitigation of adjacent cell interference caused by a gradient voltage appearing on an area of the counter electrode of an adjacent cell. Conductors that exhibit zero impedance would not exhibit any voltage gradient when higher currents are being passed. The metalized substrate can cause electrodes to exhibit lower impedance and improve operation of the potentiostat.

The electrical contacts 102 and 104 for the working electrodes and the counter electrode can generally be made from any suitable conductive material that is electrically connected to the corresponding electrodes. In one embodiment, for instance, the electrical contacts 102 and 104 are formed from a conductive silver composition, such as silver ions or a silver compound.

As shown in FIG. 3, in one embodiment, the electrochemical device 50 can optionally include an insulating strip 150 that extends over portions of the electrodes in between the electrodes and the electrical contacts. The insulating strip 150 can be used to handle the electrochemical device 50 and/or prevent against damage prior to or during use. The insulating strip 150 can also prevent the electrical contacts from having direct contact with a fluid to be tested. In this manner, the electrical contacts are prevented from interfering with the electrodes during measurement. The insulating strip 150 can be made from any suitable nonconductive material. Exemplary materials include, for example, dielectric polymeric materials such as polyesters, polyvinyl chloride, and other similar compatible polymers. The insulating strip 150 can also result in more consistent electrode exposure to the fluid to be tested. The insulating strip 150 permits the electrochemical device to be inserted into the fluid to be tested with reduced or less precise mechanical tolerance since the electrochemical device can be inserted deeper into the fluid but with consistent electrode exposure which allows for the fluid to completely or nearly completely cover the exposed electrodes.

During use of the electrochemical device 50, the electrochemical device 50 can be placed in an apparatus for measuring analytes in a fluid sample. For example, in one embodiment, the electrochemical device 50 can be placed in a holding device. The holding device can be configured to hold the electrochemical device 50 and place the device 50 into a reservoir that holds a fluid sample. An analyzing device can be connected to each of the electrodes on the electrochemical device 50 and can be designed to apply voltages to certain of the electrodes and measure electrical currents within each electrochemical cell. Based on the measured electrical current, the device can be configured to indicate an analyte concentration within the fluid sample. Of particular advantage, multiple analytes can be measured simultaneously without electrical interference.

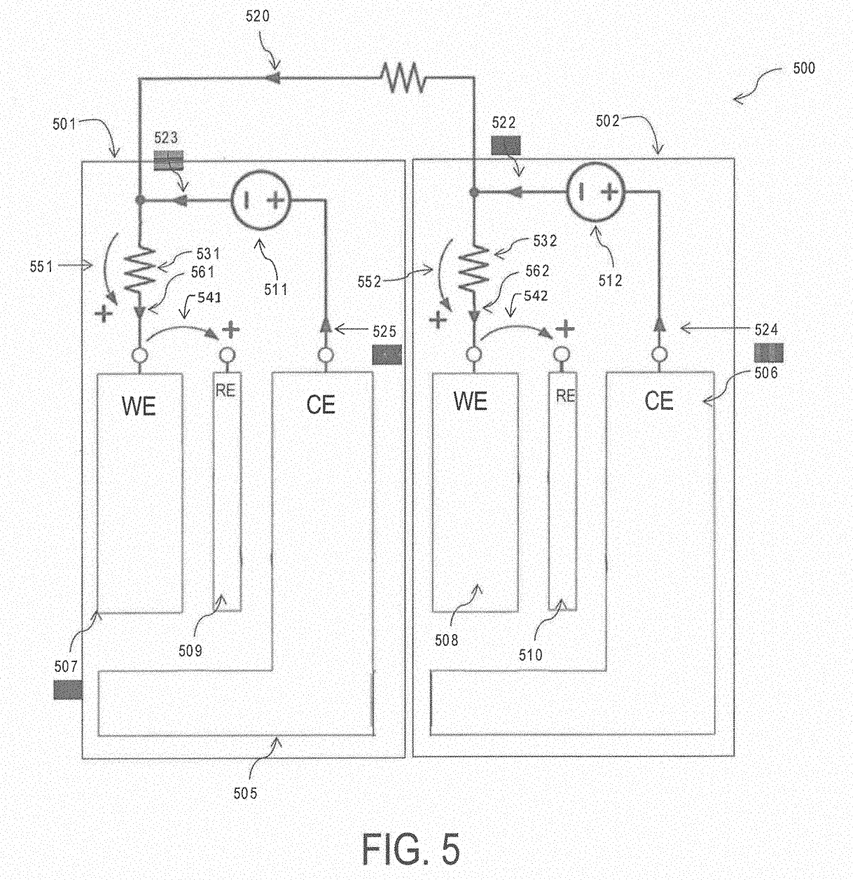

FIG. 5 depicts a diagram of a conventional potentiostat circuit including multiple conventional potentiostats which may be used for the purpose of attempting to measure analytes in an uncompartmented or galvanically connected fluid sample or electrochemical cell. Potentiostat circuit 500 includes two conventional potentiostats, first conventional potentiostat 501 and second conventional potentiostat 502. First conventional potentiostat 501 includes a counter electrode 505, working electrode 507 and reference electrode 509. Second conventional potentiostat 502 includes a counter electrode 506, working electrode 508 and reference electrode 510. Counter electrodes 505 and 506 are isolated in that they are not physically connected or otherwise in physical contact with one another. Counter electrodes 505 and 506, working electrodes 507 and 508 and reference electrodes 509 and 510, can be submerged in an uncompartmented or galvanically connected fluid sample or electrochemical cell for the purpose of measuring analytes in the fluid sample.

For conventional potentiostat 501, an input supply 511 is used to control the potential or voltage difference between working electrode 507 and reference electrode 509. The voltage difference between working electrode 507 and reference electrode 509 can be a positive voltage (V_{RE}>V_{WE}), a negative voltage (V_{RE}<V_{WE}) or an alternating current voltage either with or without a positive or negative DC voltage bias. Conventional potentiostat 501 attempts to control the voltage difference between working electrode 507 and reference electrode 509 to a first user supplied set point 541 (V_{ISET}). The first user supplied voltage set point 541 is determined by the user of conventional potentiostat 501 and is based, at least in part on, the analytes that are being measured in the electrochemical cell and the contents of the electrochemical cell. Conventional potentiostat 501 controls the voltage difference between working electrode 507 and reference electrode 509 by injecting current into the uncompartmented or galvanically connected fluid sample or electrochemical cell through counter electrode 505. Proper function of potentiostat 501 would result in a current flowing into the uncompartmented or galvanically connected fluid sample or electrochemical cell via the working electrode 507 and leaving the uncompartmented or galvanically connected fluid sample or electrochemical cell via the counter electrode 505. Consequently, proper function of potentiostat 501 would result in working electrode current 523 (I₁ₐ) being equivalent to counter electrode current 525 (I_{1b}). Conventional potentiostat 501 includes a measurement resistor 531 (R₁ₘ), which is used to obtain a measured voltage 551 (V₁ₘ). Measured voltage 551 and the resistance of measurement resistor 531 are used to measure or determine measured current 561 (V₁ₘ=I₁ₘ×R₁ₘ) which is the amount of current flowing between working electrode 507 and counter electrode 505. When conventional potentiostat 501 is operating properly measured current 561 is equivalent to working electrode current 523 (I₁ₘ−I₁ₐ). Measured current 561 (I₁ₘ) is then utilized to generate an output measurement signal proportional to the measured current 561. The output measurement signal indicates a change in the resistance between working electrode 507 and reference electrode 509 and therefore, indicates an electrochemical property of a solution in contact with counter electrode 505, working electrode 507 and reference electrode 509.

For conventional potentiostat 502, an input supply 512 is used to control the potential or voltage difference between working electrode 508 and reference electrode 510. The voltage difference between working electrode 508 and reference electrode 510 can be a positive voltage (V_{RE}>V_{WE}), a negative voltage (V_{RE}<V_{WE}) or an alternating current voltage either with or without a positive or negative DC voltage bias. Conventional potentiostat 502 attempts to control the voltage difference between working electrode 508 and reference electrode 510 to a second user supplied set point 542 (V_{2SET}). The second user supplied voltage set point 542 is determined by the user of conventional potentiostat 502 and is based, at least in part on, the analytes that are being measured in the electrochemical cell and the contents of the electrochemical cell. Conventional potentiostat 502 controls the voltage difference between working electrode 508 and reference electrode 510 by injecting current into the uncompartmented or galvanically connected fluid sample or electrochemical cell through counter electrode 506. Proper function of potentiostat 502 would result in a current flowing into the uncompartmented or galvanically connected fluid sample or electrochemical cell via the working electrode 508 and leaving the uncompartmented or galvanically connected fluid sample or electrochemical cell via the counter electrode 506. Consequently, proper function of potentiostat 502 would result in working electrode current 522 (I₂ₐ) being equivalent to counter electrode current 524 (I_{2b}). Conventional potentiostat 502 includes a measurement resistor 532 (R₂ₘ), which is used to obtain a measured voltage 552 (V₂ₘ). Measured voltage 552 and the resistance of measurement resistor 532 are used to measure or determine measured current 562 (V₂ₘ=I₂ₘ×R₂ₘ) which is the amount of current flowing between working electrode 508 and counter electrode 506. When conventional potentiostat 502 is operating properly measured current 562 is equivalent to working electrode current 522 (I₂ₘ=I₂ₐ). Measured current 562 (I₂ₘ) is then utilized to generate an output measurement signal proportional to the measured current 562. The output measurement signal indicates a change in the resistance between working electrode 508 and reference electrode 510 and therefore, indicates an electrochemical property of a solution in contact with counter electrode 506, working electrode 508 and reference electrode 510. The conventional potentiostat circuit topology can include an output device to receive the measurement output signal.

When conventional potentiostat 501 and conventional potentiostat 502 are operated simultaneously, the voltage applied to counter electrode 505 may be different as compared to the voltage applied to counter electrode 506. When different voltages are simultaneously applied to counter electrode 505 and counter electrode 506, each counter electrode injects different amounts of current into the same uncompartmented or galvanically connected fluid sample or electrochemical cell. This condition can cause a current imbalance between conventional potentiostat 501 and conventional potentiostat 502. This condition can also cause leakage current 520 (I_{LEAK}) to flow between conventional potentiostat 501 and conventional potentiostat 502. For example, leakage current 520 (I_{LEAK}) can include a portion of the working electrode current 522 (I₂ₐ) from conventional potentiostat 502 and leakage current 520 may travel through the uncompartmented or galvanically connected fluid sample or electrochemical cell to counter electrode 505 of conventional potentiostat 501. As such, rather than only current from working electrode 507 leaving the electrochemical cell via counter electrode 505, the current leaving the electrochemical cell via counter electrode 505 will include current from working electrode 507 and leakage current 520 (I_{LEAK}+I₂ₐ). Consequently, the current flowing through measurement resistor 551 (I₂ₘ) of conventional potentiostat 501 would include working electrode current 523 and leakage current 520 (I_{LEAK}+I₂ₐ). As a result, the current flowing through the uncompartmented or galvanically connected fluid sample or electrochemical cell between working electrode 508 and counter electrode 506 would be different than the current value determined or calculated using the measured voltage 551 (V₂ₘ=R₂ₘ (I_{LEAK}+I₂ₐ)), which is obtained at measurement resistor 531. Consequently, controllers for conventional potentiostat 501 and conventional potentiostat 502 will be unable to properly regulate or control the voltage difference between their respective working electrodes (507 and 508) and reference electrodes (509 and 510) and fail to produce accurate and meaningful results.

While leakage current 520 has been described as flowing from conventional potentiostat 502 to conventional potentiostat 501, this example is provided by way of explanation and not limitation. Those skilled in the art will appreciate that in certain operating conditions, leakage current 520 could also flow from conventional potentiostat 501 to conventional potentiostat 502 or flow between any number of conventional potentiostats which may be submerged or used in the same uncompartmented or galvanically connected fluid sample or electrochemical cell.

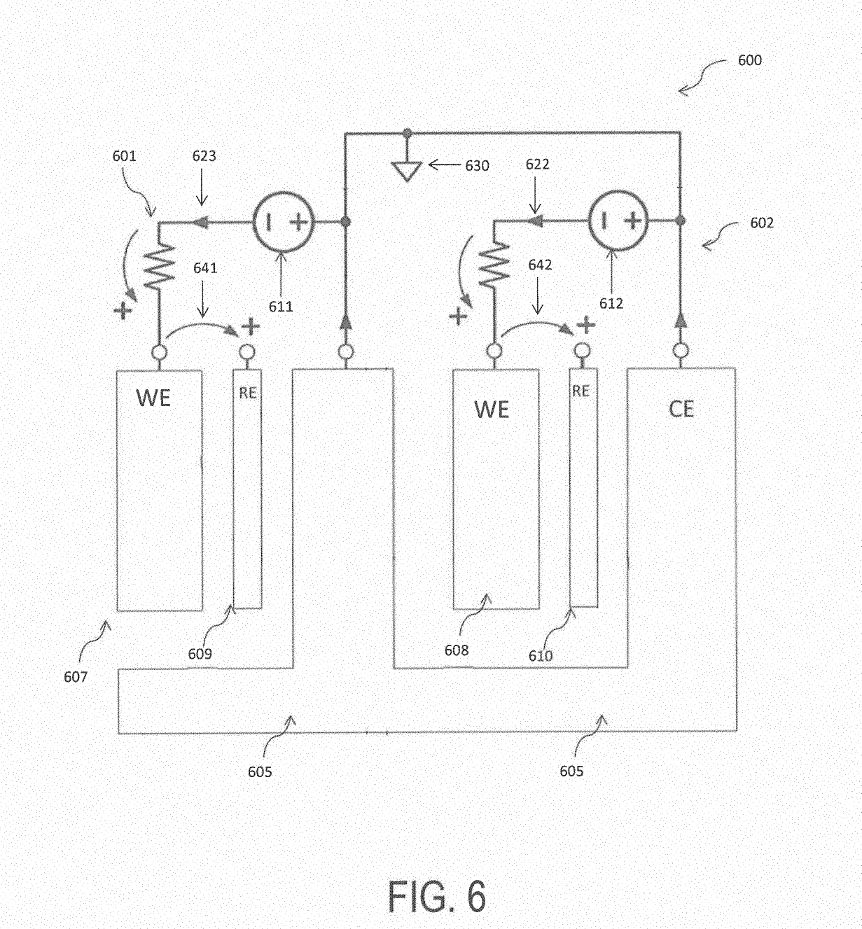

FIG. 6 depicts a diagram of an example non-conventional potentiostat circuit according to example embodiments of the present disclosure. Non-conventional potentiostat circuit 600 includes two non-conventional potentiostats, such as first non-conventional potentiostat 601 and second non-conventional potentiostat 602. Non-conventional potentiostat 601 includes a working electrode 607, a reference electrode 609 and a common counter electrode 605, which is shared with, physically connected to or otherwise in direct electrical contact with the counter electrode of non-conventional potentiostat 602. Counter electrode 605 is depicted in FIG. 6 with a unitary construction; however, those skilled in the art will appreciate that other configurations may be utilized for common counter electrode 605. For example, common counter electrode 605 can include multiple counter electrodes that are physically connected or otherwise in direct electrical contact with one another. Non-conventional potentiostat 602 includes a working electrode 608, a reference electrode 610 and the common counter electrode 605. Non-conventional potentiostat 601 and 602 share or are each physically connected or otherwise in direct electrical contact with common counter electrode 605.

The common counter electrode 605, working electrodes 607 and 608 and reference electrodes 609 and 610, can be submerged in an uncompartmented or galvanically connected fluid sample for the purpose of measuring analytes in the fluid sample. For each non-conventional potentiostat 601 and 602, an input supply 611, 612 is used to control a voltage difference (641 and 642) between the working electrodes (607 and 608) and the reference electrodes (609 and 610). The common counter electrode 605 is held at a common potential voltage, such as at circuit ground 630 (+0V DC), and is configured to prevent against electrical interference, leakage current, between non-conventional potentiostat 601 and 602 when measuring analytes in a fluid sample.

Unlike conventional potentiostats, such as potentiostats 501 and 502 depicted in FIG. 5, which control the voltage difference between a working electrode, such as working electrodes 507 or 508, and a reference electrode, such as reference electrodes 509 or 510, by injecting current into the uncompartmented or galvanically connected fluid sample or electrochemical cell through a counter electrode, such as counter electrodes 505 or 505, non-conventional potentiostats, such as potentiostats 601 and 602, control the voltage difference between a working electrode and a reference electrode via the working electrode.

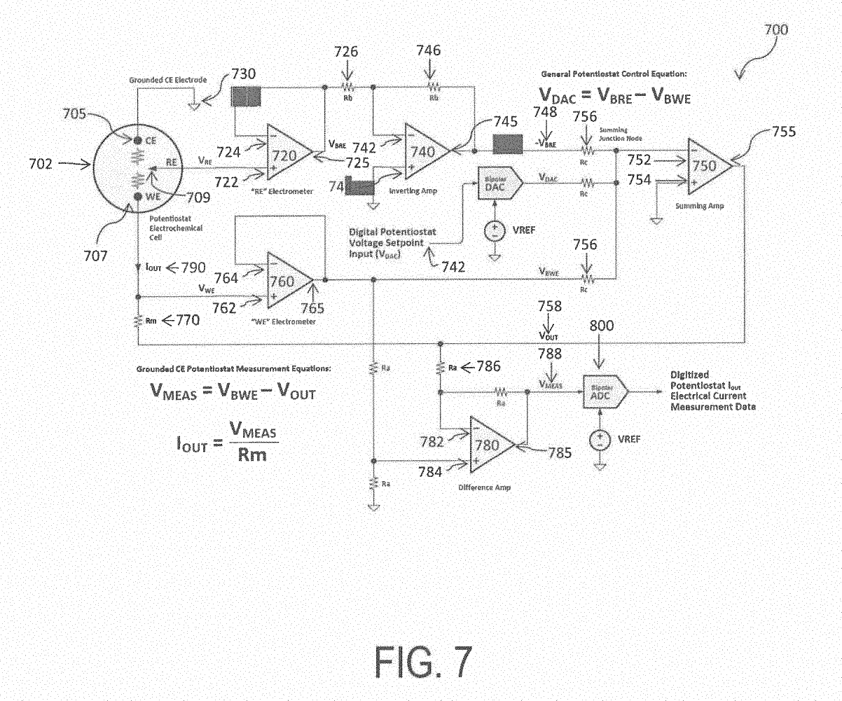

For non-conventional potentiostat 601, an input supply 611 is used to control the potential or voltage difference 641 between working electrode 607 and reference electrode 609. The voltage difference between working electrode 607 and reference electrode 609 can be a positive voltage (V_{RE}>V_{WE}), a negative voltage (V_{RE}<V_{WE}) or an alternating current voltage either with or without a positive or negative DC voltage bias. Non-conventional potentiostat 601 controls the voltage difference between working electrode 607 and reference electrode 609 such that the voltage difference is equivalent or nearly equivalent to a first user supplied set point 641 (V_{ISET}). The first user supplied voltage set point 641 is determined by the user of non-conventional potentiostat 601 and is based, at least in part on, the analytes that are being measured in the electrochemical cell and the contents of the electrochemical cell. Non-conventional potentiostat 601 controls the voltage difference 641 between working electrode 607 and reference electrode 609 by injecting current into the uncompartmented or galvanically connected fluid sample or electrochemical cell through working electrode 607. In this configuration, and as a more fully described in FIG. 7, a first high impedance circuit component is connected to working electrode 607 and a second high impedance circuit component is connected to reference electrode 609. Non-conventional potentiostat 601 controls the voltage difference between working electrode 607 and reference electrode 609 by permitting dynamic changes in voltage, relative to ground, of both the working electrode 607 and reference electrode 609.

When the common counter electrode 605 is held at a common potential voltage, proper function of the first non-conventional potentiostat 601 would result in voltage being applied by the input supply 611 to working electrode 607, and permits the maintenance of a constant cell reference voltage 641 between the working electrode 607 and the reference electrode 609, by permitting dynamic changes in voltage, relative to ground, of both the working electrode 607 and reference electrode 609. Similarly, when the common counter electrode 605 is held at a common potential voltage, proper function of the second non-conventional potentiostat 602 would result in voltage being applied by the input supply 612 to working electrode 608, and permits the maintenance of a constant cell reference voltage 642 between the working electrode 608 and the reference electrode 610 by permitting dynamic changes in voltage, relative to ground, of both the working electrode 608 and reference electrode 610.

Proper function of non-conventional potentiostats 601 and 602 result in working electrode current 622 (I₁ₐ) and working electrode current 623 (I₂ₐ) to be injected into and traveling through the uncompartmented or galvanically connected fluid sample or electrochemical cell to the common counter electrode 605 and to ground 630. In this respect, non-conventional potentiostats 601 and 602 prevent leakage current from flowing between electrochemical cells.

FIG. 7 depicts a diagram of an electrical schematic of a non-conventional potentiostat circuit according to example embodiments of the present disclosure. Potentiostat circuit 700 includes a three terminal electrochemical cell 702. Potentiostat circuit 700 includes a common counter electrode 705, working electrode 707 and reference electrode 709, which can be part of an electrochemical sensor such as those depicted in FIGS. 1 through 4, and said electrodes can be submerged in an uncompartmented or galvanically connected fluid sample for the purpose of measuring analytes in the fluid sample.

Common counter electrode 705 is held at a common potential voltage, such as at circuit ground 730 (+0V DC). A user supplied set point 742 (V_{DAC}), which is determined by the user of potentiostat 700 and is based, at least in part on, the analytes that are being measured in the electrochemical cell and the contents of the electrochemical cell, is input into the potentiostat circuit 700, by a digital to analog converter or another known device of similar function. Potentiostat circuit 700 controls the voltage difference between working electrode 707 and reference electrode 709 to be equal or nearly equivalent to the user the supplied set point 742 (V_{DAC}).

Reference electrode 709 is connected to a first input terminal 722 of a first high impedance device, such as electrometer 720. Electrometer is used to measure the voltage present (V_{RE}) at reference electrode 709. Voltage (V_{RE}) of reference electrode 709 is received by electrometer 720 and electrometer 720 produces and output voltage (V_{BRE}). The output voltage (V_{BRE}) of electrometer 720 is connected to a second input terminal 724 of electrometer 720 such that the output voltage (V_{BRE}) of electrometer 720 is received by the second input terminal 724. Electrometer 720 can detect an imbalance between the signals received by the first input terminal 722 and the second input terminal 724. Electrometer 720 can function as a voltage follower in that after detecting an imbalance between the signals received by the first input terminal 722 and the second input terminal 724, it can maintain a null difference between them by adjusting the output voltage until such time as V_{RE} equals V_{BRE} or V_{RE} is nearly V_{BRE}.

Output terminal 725 of electrometer 720 is connected in series to one or more resistors 726, and the first input terminal 742 of an inverting amplifier 740. Second input terminal 744 of inverting amplifier 740 is connected to ground. Output terminal 745 of inverting amplifier 740 is connected in series to one or more feedback resistors 746 and to first input terminal 742, to provide feedback to inverting amplifier 740 and produce closed loop operation. Resistor 726 and feedback resistor 746 are of equal or near equal value such that the gain of the inverting amplifier 740 is negative one (−1) and the inverting amplifier 740 produces an output 748 (−V_{BRE}) which is the complementary form of V_{BRE}.

Working electrode 707 is connected to a first input terminal 762 of a second high impedance device, such as electrometer 760. Electrometer is used to measure the voltage present (V_{WE}) at working electrode 707. Voltage (V_{WE}) of working electrode 709 is received by electrometer 760 and electrometer 760 produces and output voltage (V_{BWE}). The output voltage (V_{BWE}) of electrometer 760 is connected to a second input terminal 764 of electrometer 760 such that the output voltage (V_{BWE}) of electrometer 760 is received by the second input terminal 764. Electrometer 760 can detect an imbalance between the signals received by the first input terminal 762 and the second input terminal 764. Electrometer 760 can function as a voltage follower in that after detecting an imbalance between the signals received by the first input terminal 762 and the second input terminal 764, it can maintain a null difference between them by adjusting the output voltage until such time as V_{WE} equals V_{BWE} or V_{WE} is nearly V_{BWE}.

Output terminal 765 of electrometer 760 is connected in series to one or more resistors 756 and to the first input terminal 752 of a non-inverting summing amplifier 750. Output terminal 745 of inverting amplifier 740 is connected in series to one or more resistors 756, and the first input terminal 752 of a non-inverting summing amplifier 750. Second input terminal 754 of summing amplifier 750 is connected to ground. Output 758 (V_{OUT}) of summing amplifier 750 is the sum of V_{BWE}, V_{DAC} and −V_{BRE}. Output 758 (V_{OUT}) is a control voltage that is created to assure that V_{DAC}=V_{BWE}−V_{BRE}.

Output terminal 755 of summing amplifier 750 is connected in series to one or more resistors 786, and the first input terminal 782 of a difference amplifier 780. Output terminal 765 of electrometer 760 is connected in series to one or more resistors 786 and to the second input terminal 782 of a difference amplifier 780. Output voltage 788 (V_{MEAS}) of difference amplifier 780 is equivalent to the difference of V_{BWE} and V_{OUT} (V_{MEAS}=V_{BWE}−V_{OUT}).

Working electrode 707 is connected in series with a measurement resistor 770 (Rₘ). Output voltage 788 (V_{MEAS}) of difference amplifier 780 is used with a measurement resistor 770 (Rₘ) to determine measured current 790 (I_{OUT}), which is the current flow between working electrode 707 and counter electrode 705 within electrochemical cell 702 (I_{OUT}=V_{MEAS}/Rₘ). Measured current 790 (I_{OUT}), is then utilized to generate an output measurement signal proportional to the measured current 790. The output measurement signal indicates a change in the measured current 790 (I_{OUT}), and therefore, indicates an electrochemical property of a solution in contact with counter electrode 705, working electrode 707 and reference electrode 709. Potentiostat circuit 700 includes an output device, bipolar analog to digital converter 800, to receive the measurement output signal and process the same for use with additional analog or digital devices.

A single potentiostat circuit 700 is depicted in FIG. 7. However, it will be appreciated by those skilled in the art that multiple potentiostat circuits, which are each identical to potentiostat circuit 700, may be used to simultaneously measure analytes in the same uncompartmented or galvanically connected fluid sample or electrochemical cell when the non-conventional potentiostats share a common counter electrode 705 or the counter electrodes from each of the multiple potentiostats are physically connected or otherwise in direct electrical contact with one another.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. An electrochemical sensor comprising:
a support having a first side and a second and opposite side;
at least one electrochemical cell disposed on the first side of the support, the at least one electrochemical cell including a reference electrode having an end that is contiguous with a first side and a second side, a working electrode spaced from the reference electrode that also has an end that is contiguous with a first side and a second side, and a counter electrode, the counter electrode having a shape that defines an electrode receiving area, the electrode receiving area surrounding the first side, the second side, and the end of the reference electrode and the working electrode; and
a reagent composition associated with the working electrode, the reagent composition being formulated to generate a current when contacted with a first analyte in a fluid when a voltage difference exists between the reference electrode and the working electrode.

2. An electrochemical sensor as defined in claim 1, wherein the electrochemical sensor includes a plurality of electrochemical cells disposed on the first side of the support, each electrochemical cell including a reference electrode and a working electrode and wherein the counter electrode comprises a common counter electrode for each electrochemical cell defining a plurality of electrode receiving areas, and wherein the reference electrode and the working electrode of each electrochemical cell are positioned within a corresponding electrode receiving area on the common counter electrode.

3. An electrochemical sensor as defined in claim 2, wherein each working electrode is associated with a different reagent composition for detecting a different analyte in a fluid contacted with the electrochemical sensor.

4. An electrochemical sensor as defined in claim 1, wherein the counter electrode has a U-like shape that defines the electrode receiving area.

5. An electrochemical sensor as defined in claim 2, wherein the common counter electrode comprises an array of interconnected U-shaped sections, each U-shaped section serving as a counter electrode for a corresponding electrochemical cell, each U-shaped section defining a corresponding electrode receiving area.

6. An electrochemical sensor as defined in claim 3, wherein the electrochemical sensor includes a first reagent composition associated with the working electrode in a first electrochemical cell, the first reagent composition being an indicator for total alkalinity of a fluid contacting the electrochemical sensor, the electrochemical sensor further including a second reagent composition associated with the working electrode in a second electrochemical cell, the second reagent composition being an indicator for chlorine in a fluid contacting the electrochemical sensor.

7. An electrochemical sensor as defined in claim 2, wherein the electrochemical sensor includes from about 3 to about 12 electrochemical cells.

8. An electrochemical sensor as defined in claim 1, wherein the reagent composition is formulated to detect an analyte found in blood.

9. An electrochemical sensor as defined in claim 1, wherein the reagent composition is formulated to detect an analyte comprising glucose.

10. An electrochemical sensor as defined in claim 1, wherein the counter electrode is maintained at a common voltage.

11. An electrochemical sensor as defined in claim 1, wherein the counter electrode comprises a grounded electrode.

12. An electrochemical sensor as defined in claim 1, wherein at least one of the electrodes comprises a metal trace layer and a carbon trace layer.

13. An electrochemical sensor as defined in claim 12, wherein the carbon trace layer is positioned over the metal trace layer, the metal trace layer having a width that is less than a width of the carbon trace layer.

14. An electrochemical sensor as defined in claim 2, further comprising an additional electrochemical cell that is galvanically isolated from the plurality of electrochemical cells, the isolated electrochemical cell including a reference electrode, a working electrode, and a counter electrode that is separate from the common counter electrode.

15. An electrochemical sensor as defined in claim 14, wherein the isolated electrochemical cell includes a reagent composition associated with the working electrode, the reagent composition being an indicator for cyanuric acid of a fluid contacting the electrochemical sensor.

16. An electrochemical sensor as defined in claim 14, wherein the support defines a slot that separates the isolated electrochemical cell from the plurality of electrochemical cells.

17. An electrochemical sensor as defined in claim 2, wherein the plurality of electrochemical cells includes at least one terminal electrochemical cell positioned at an end of the plurality of electrochemical cells, the terminal electrochemical cell including a reference electrode and a working electrode and sharing the common counter electrode with the remainder of the plurality of electrochemical cells, the common counter electrode being located only on one side of the reference electrode and the working electrode of the terminal electrochemical cell.

18. An electrochemical sensor as defined in claim 6, further comprising at least a third electrochemical cell and a fourth electrochemical cell, the third electrochemical cell including a third reagent composition associated with the working electrode of the cell and the fourth electrochemical cell including a fourth reagent composition associated with the working electrode of the cell, and wherein the third reagent composition is different from the fourth reagent composition and wherein the third reagent composition and the fourth reagent composition are indicators for analytes comprising copper, borate, bromine, iron, or calcium.

19. An electrochemical sensor as defined in claim 2, further comprising a plurality of electrical contacts and wherein each of the electrodes is electrically connected to a separate contact.

20. An electrochemical sensor as defined in claim 19, wherein the plurality of electrical contacts are disposed on the support and wherein the electrochemical cell further includes an insulating strip that extends over portions of the electrodes in between the electrodes and the electrical contacts.

21. An electrochemical sensor as defined in claim 2, wherein each electrochemical cell is configured to simultaneously sense a different analyte in a fluid contacting the electrochemical sensor.

22. An electrochemical sensor as defined in claim 1, wherein the counter electrode is spaced a distance from the working electrode that is greater than the space between the working electrode and the reference electrode.

23. An electrochemical sensor as defined in claim 22, wherein the distance between the counter electrode and the working electrode is greater than 1 to up to 5 times greater than the distance between the reference electrode and the working electrode.

24. An apparatus for measuring analytes in a fluid comprising;
a reservoir for holding a fluid;
a holding device for the electrochemical sensor defined in claim 2; and
an analyzing device that electrically connects to each of the electrodes on the electrochemical sensor, the analyzing device being configured to provide a common voltage to the common counter electrode and to control voltage differences between the working electrode and the reference electrode in each electrochemical cell for simultaneously measuring different analytes loaded into the fluid reservoir.
